(19) United States
(12) Patent Application Publication
(10) Pub. No.: US 2015/0207258 A1
(43) Pub. Date: Jul. 23, 2015

(54) CONNECTING CABLE

(71) Applicant: Toyota Jidosha Kabushiki Kaisha, Toyota-shi Aichi-ken (JP)

(72) Inventor: Yasuyuki Moriuchi, Toyota-shi Aichi-ken (JP)

(21) Appl. No.: 14/599,913

(22) Filed: Jan. 19, 2015

(30) Foreign Application Priority Data
Jan. 21, 2014 (JP) 2014-008612

(51) Int. Cl. H01R 13/42; H01R 4/70

(52) U.S. Cl. CPC H01R 13/42; H01R 4/70

(57) ABSTRACT

A connecting cable includes three coated wires 21 each formed by coating a conductor 22 with an insulating coating material 23, a terminal housing 11 having nozzle-shaped members 16 for receiving the respective coated wires 21, insulating tubes 24 spaced from the nozzle-shaped members 16 and covering the respective outer surfaces of the coated wires 21, and a tubular grommet 25 attached to the terminal housing 11 and arranged overlapping the outer periphery of the insulating tubes 24, the grommet 25 having the three coated wires 21 inserted therein. With this structure, insulating performance of the overall connecting cable is enhanced.

### PRIORITY INFORMATION

This application claims priority to Japanese Patent Application No. 2014-008612 filed on Jan. 21, 2014, which is incorporated herein by reference in its entirety.

### TECHNICAL FIELD

The present invention relates to a structure of a connecting cable.

### BACKGROUND ART

In an electrically-driven vehicle such as an electric automobile and a hybrid automobile, a wire harness (connecting cable) for high voltage use is used to connect between high voltage devices, such as between a motor and an inverter unit and between an inverter unit and a battery. Because such a wire harness radiates electromagnetic waves, it has been proposed, for example, to provide an electromagnetic seal by using a pipe-shaped, electrically-conductive protection member to cover the exterior of high voltage electric wires having insulating coating. Also, it has been proposed to provide molded resin over the protection member so as to simultaneously achieve protection of the wire harness, routing control (maintenance of shape), and increased insulating performance (for example, see JP 2013-99074 A). Further, there has been proposed a method of covering the outer periphery of a cable with a corrugated tube so as to achieve protection of wires and enhanced insulating property (for example, see JP 2012-249506 A).

Typically, a connecting cable is used in a form having many bent portions in order to connect between devices such as a motor and an inverter. For this reason, when a coated wire inside the connecting cable is covered with an insulating material such as a tube, the bent portions may cause a difference between the length of the coated wire and the length of the tube. There may also be cases in which a difference is caused between the length of the coated wire and the length of the tube due to manufacturing errors and the like. Meanwhile, in view of making connection to a terminal, a cable is often manufactured with a tolerance that results in the length of the coated wire being slightly longer than the tube on the outer surface. Consequently, end portions of the coated wire become exposed from the two ends of the tube (insulating material). As such, there have been difficulties in covering the coated wire continuously from one end portion to the other end portion with a tube (insulating material). This resulted in the problem of degraded insulating performance at the two end portions which are not covered with the tube (insulating material), which lead to reduction in the insulating property of the overall connecting cable.

An object of the present invention is to enhance the insulating performance of a connecting cable as a whole.

### SUMMARY

A connecting cable according to the present invention comprises at least one coated wire formed by coating a conductor with an insulating coating material, a terminal housing having a nozzle-shaped member for receiving one end portion of the coated wire, a first insulating member spaced from the nozzle-shaped member and covering an outer surface of the coated wire, and a second insulating member attached to the terminal housing and arranged overlapping an outer periphery of the first insulating member, the second insulating member having a tubular shape into which the coated wire is inserted.

In the connecting cable of the present invention, it is also preferable to configure such that the nozzle-shaped member and a part of the coated wire covered with the first insulating member are inserted inside the second insulating member.

In the connecting cable of the present invention, the second insulating member may be bendable together with the at least one coated wire inserted therein, and it is also preferable to configure such that the second insulating member physically defines a route of the at least one coated wire inserted therein.

A connecting cable according to the present invention comprises: at least one coated wire formed by coating a conductor with an insulating coating material; a first terminal housing having at least one first nozzle-shaped member for receiving a portion of the coated wire on a first end side; a second terminal housing having at least one second nozzle-shaped member for receiving a portion of the coated wire on a second end side; a first insulating member spaced from the first nozzle-shaped member and the second nozzle-shaped member and covering an outer surface of the coated wire; a third insulating member attached to the first terminal housing and arranged overlapping an outer periphery of the first insulating member, the third insulating member having a tubular shape into which the coated wire is inserted; and a fourth insulating member attached to the second terminal housing and arranged overlapping an outer periphery of the first insulating member, the fourth insulating member having a tubular shape into which the coated wire is inserted. The third insulating member is bendable together with the at least one coated wire inserted therein, and the fourth insulating member physically defines a route of the at least one coated wire inserted therein.

In the connecting cable of the present invention, it is also preferable to configure such that the first nozzle-shaped member and a part of the coated wire located on the first end side and covered with the first insulating member are inserted inside the third insulating member, while the second nozzle-shaped member and a part of the coated wire located on the second end side and covered with the first insulating member are inserted inside the fourth insulating member.

### Advantages of the Invention

The present invention is capable of achieving the advantageous effect of enhancing the insulating performance of a connecting cable as a whole.

### BRIEF DESCRIPTION OF THE DRAWINGS

Preferred embodiments of the present invention will be described in detail based on the following figures, wherein:

FIG. 1 shows a cross-sectional plan view of a connecting cable according to an embodiment of the present invention;

FIG. 2 shows a cross-sectional plan view of a connecting cable according to another embodiment of the present invention;

FIG. 3A shows a cross-sectional side view of a connecting cable according to FIG. 1; and

FIG. 3B shows a cross-sectional side view of a connecting cable according to FIG. 2.

### DESCRIPTION OF EMBODIMENTS

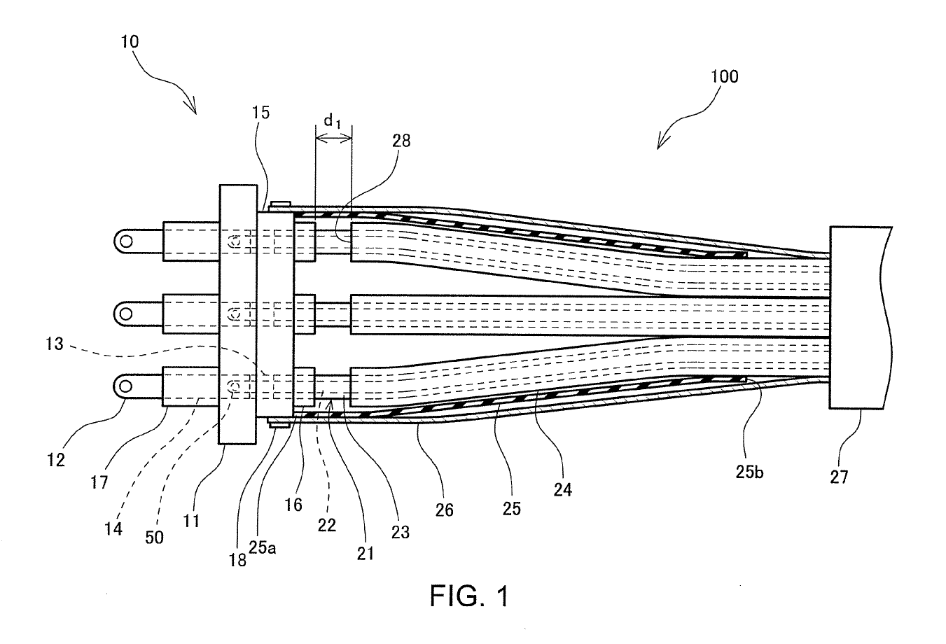

Embodiments of the present invention are described below with reference to the drawings. As shown in FIG. 1, a connecting cable 100 of the present embodiment comprises: three coated wires 21 each formed by coating a conductor 22 with an insulating coating material 23; a connector 10 that retains terminals 12 to which the conductors 22 of the coated wires 21 are connected; insulating tubes 24 serving as a first insulating member and covering the respective outer surfaces of the coated wires 21; a grommet 25 arranged overlapping the outer periphery of the insulating tubes 24 covering the outer surfaces of the three coated wires 21, the grommet 25 serving as a second insulating member and having a tubular shape into which the three coated wires 21 are inserted; a braided shield 26 covering the exterior of the grommet 25; and a protection tube 27 having inserted therein the three coated wires 21 with their respective outer surfaces covered with the insulating tubes 24, the protection tube 27 also having the braided shield 26 placed therein.

As shown in FIG. 1, the connector 10 comprises metal terminals 12 and a terminal housing 11 composed of an insulator such as resin. The terminal housing 11 includes terminal mounting portions 17 having slits 14 into which the terminals 12 are fitted, a base 15 provided on a side opposite to the terminals 12, and three nozzle-shaped members 16 arranged on the base 15. The terminal housing 11 has therein three independent cavities 13 for receiving the coated wires 21. Each cavity 13 corresponds to an opening of the corresponding nozzle-shaped member 16, and the respective cavities 13 are in communication with the corresponding slits 14 into which the terminals 12 are fitted. As shown in FIG. 1, each coated wire 21 is inserted from the corresponding nozzle-shaped member 16 into the corresponding cavity 13. The conductor 22 of each coated wire 21 is connected to the corresponding terminal 12 by means of a connecting member 50 inside the corresponding cavity 13. Concerning each coated wire 21 inserted into the corresponding nozzle-shaped member 16, the outer surface of a part of the coated wire 21 is covered with the corresponding insulating tube 24 serving as the first insulating member, the covered part being the part of the coated wire 21 extending from a first position 28, which is a position spaced from the corresponding nozzle-shaped member 16 by distance d₁, toward a side opposite to the nozzle-shaped member 16.

A first end 25a of the grommet 25 serving as the second insulating member is attached to an end face of the base 15 of the terminal housing 11. The grommet 25 is composed of a resilient material having an insulating property, such as rubber. As shown in FIG. 1, the grommet 25 is tubular, and extends from its first end 25a to second end 25b. Inside the grommet 25, there are placed parts of the three coated wires 21 extending between the corresponding nozzle-shaped members 16 and the corresponding first positions 28, which are not covered with the insulating tubes 24, and there are also placed parts of the three coated wires 21 extending from the first positions 28 toward the side opposite to the nozzle-shaped members 16, which are covered with the insulating tubes 24, respectively. Accordingly, the conductors 22 in the parts of the three coated wires 21 extending between the nozzle-shaped members 16 and the first positions 28 (i.e., extending across the distance d₁) and not covered with the insulating tubes 24 are insulated by two insulating layers, namely, the insulating coating material 23 on the coated wires 21 and the grommet 25. Further, the parts of the coated wires 21 extending between the first positions 28 and the second end 25b of the grommet are insulated by three insulating layers, namely, the insulating coating material 23 on the coated wires 21, the insulating tubes 24, and the grommet 25.

As shown in FIG. 1, the braided shield 26 is attached to the outer periphery of the base 15 of the terminal housing 11 by a fastening band 18. The end of the braided shield 26 attached to the base 15 is connected by means of a connecting member (not shown) to a grounding part provided on a terminal board of a motor, inverter, or the like. The braided shield 26 covers the outer surface of the grommet 25 and extends beyond the second end 25b of the grommet 25 to cover the exterior of the insulating tubes 24 covering the respective coated wires 21, thereby providing an electromagnetic seal. The exterior of the braided shield 26 is sheathed with the protection tube 27. The protection tube 27 may be flexible, or may be a resin-molded member configured to physically define the route of the connecting cable 100. It should be noted that the part of the connecting cable 100 extending between the connector 10 and the protection tube 27 can be bent freely.

According to the connecting cable 100 of the above-described embodiment, the conductors 22 in the parts of the three coated wires 21 extending between the nozzle-shaped members 16 and the first positions 28 (i.e., extending across the distance d₁) and not covered with the insulating tubes 24 are insulated by two insulating layers, namely, the insulating coating material 23 on the coated wires 21 and the grommet 25, while the other parts of the coated wires 21 are insulated by three insulating layers, namely, the insulating coating material 23 on the coated wires 21, the insulating tubes 24, and the grommet 25. In this way, over the entire connecting cable 100, the conductors 22 of the three coated wires 21 are always insulated by two or more insulating layers. As a result, insulating performance of the overall connecting cable 100 can be enhanced.

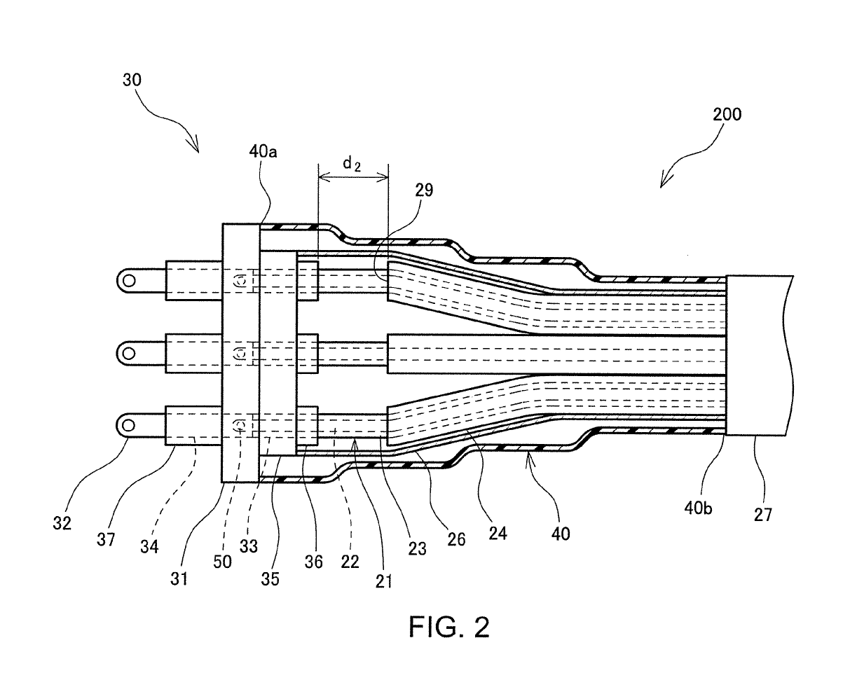

Next, another embodiment of the present invention is described with reference to FIG. 2. In the connecting cable 200 of the present embodiment, instead of providing the grommet 25 of the above-described embodiment, a resin-molded protector 40 that physically defines the route of the coated wires 21 is provided covering substantially the entire connecting cable 200. Accordingly, the protector 40 serves as the second insulating member. Elements in FIG. 2 that are identical to those described with reference to FIG. 1 are labeled with the same numerals, and explanation of those elements will not be repeated.

As shown in FIG. 2, the connector 30 in the connecting cable 200 of the present embodiment comprises metal terminals 32 and a terminal housing 31 composed of an insulator such as resin. The terminal housing 31 includes terminal mounting parts 37 having slits 34 into which the terminals 32 are fitted, a base 35 provided on a side opposite to the terminals 32, and three nozzle-shaped members 36 arranged on the base 35. The terminal housing 31 has therein three independent cavities 33 for receiving the coated wires 21. Each cavity 33 corresponds to an opening of each nozzle-shaped member 36, and the respective cavities 33 are in communication with the corresponding slits 34 into which the terminals 32 are fitted. As shown in FIG. 2, each coated wire 21 is inserted from the corresponding nozzle-shaped member 36 into the corresponding cavity 33. The conductor 22 of each coated wire 21 is connected to the corresponding terminal 32 by means of a connecting member 50 inside the corresponding cavity 33. Concerning each coated wire 21 inserted into the corresponding nozzle-shaped member 36, the outer surface of a part of the coated wire 21 is covered with the corresponding insulating tube 24 serving as the first insulating member, the covered part being the part of the coated wire 21 extending from a second position 29, which is a position spaced from the corresponding nozzle-shaped member 36 by distance d₂, toward a side opposite to the nozzle-shaped member 36.

The braided shield 26 is attached to an end face of the base 35 of the terminal housing 31. The end of the braided shield 26 attached to the base 35 is connected by means of a connecting member (not shown) to a grounding part provided on a terminal board of a motor, inverter, or the like. The braided shield 26 covers the exterior of the insulating tubes 24 covering the respective coated wires 21, thereby providing an electromagnetic seal.

Further, a first end 40a of the protector 40 serving as the second insulating member is attached to an end face of the terminal housing 31. The protector 40 is a component manufactured by molding resin, and has an insulating property. In addition, the protector 40 has a rigid, fixed shape, and thereby serves to physically define the route of the coated wires 21, braided shield 26, and the like retained inside. The protector 40 may be a tubular component molded into a single piece with resin. Alternatively, for example, the protector 40 may have a two-piece structure including an upper piece and a lower piece, which are assembled into tubular form after placing the coated wires 21, braided shield 26, and the like on the inside. As shown in FIG. 2, the following elements are inserted in the protector 40: the three nozzle-shaped members 36; parts of the three coated wires 21 extending between the corresponding nozzle-shaped members 36 and the corresponding second positions 29, which are not covered with the insulating tubes 24; and parts of the three coated wires 21 extending from the second positions 29 toward the side opposite to the nozzle-shaped members 36, which are covered with the insulating tubes 24, respectively. Accordingly, the conductors 22 in the parts of the three coated wires 21 extending between the nozzle-shaped members 36 and the second positions 29 (i.e., extending across the distance d₂) and not covered with the insulating tubes 24 are insulated by two insulating layers, namely, the insulating coating material 23 on the coated wires 21 and the protector 40. Further, the parts of the coated wires 21 extending between the second positions 29 and the second end 40b of the protector 40 are insulated by three insulating layers, namely, the insulating coating material 23 on the coated wires 21, the insulating tubes 24, and the protector 40.

According to the connecting cable 200 of the above-described embodiment, similarly to in the connecting cable 100 of the first embodiment, the conductors 22 in the parts of the three coated wires 21 extending between the nozzle-shaped members 36 and the second positions 29 (i.e., extending across the distance d₂) and not covered with the insulating tubes 24 are insulated by two insulating layers, namely, the insulating coating material 23 on the coated wires 21 and the protector 40, while the other parts of the coated wires 21 are insulated by three insulating layers, namely, the insulating coating material 23 on the coated wires 21, the insulating tubes 24, and the protector 40. In this way, over the entire connecting cable 200, the conductors 22 of the three coated wires 21 are always insulated by two or more insulating layers. As a result, insulating performance of the overall connecting cable 200 can be enhanced.

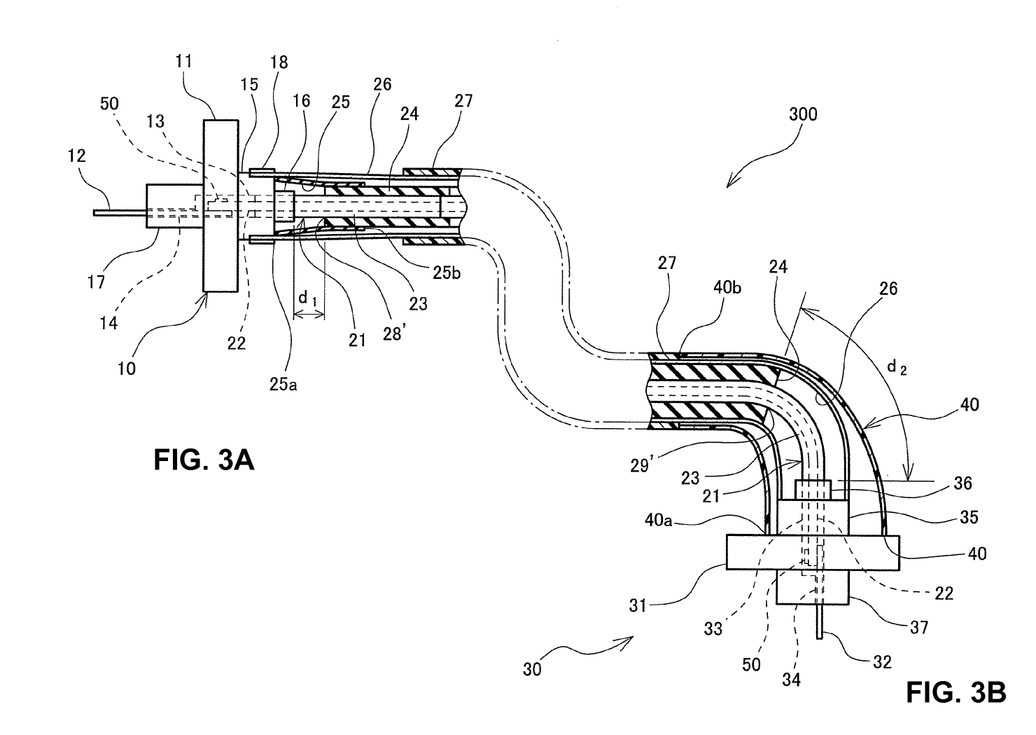

Next, a connecting cable 300, which is another embodiment of the present invention, is described with reference to FIGS. 3A and 3B. Elements in FIGS. 3A and 3B that are identical to those described with reference to FIGS. 1 and 2 are labeled with the same numerals, and explanation of those elements will not be repeated. The present embodiment is configured by combining, into a single cable, the connecting cable 100 having attached thereto the connector 10 described with reference to FIG. 1, and the connecting cable 200 having attached thereto the connector 30 described with reference to FIG. 2. FIG. 3A shows a cross-sectional side view of the connecting cable 100 described with reference to FIG. 1, while FIG. 3B shows a cross-sectional side view of the connecting cable 200 described with reference to FIG. 2.

The connecting cable 300 shown in FIGS. 3A and 3B comprises the three coated wires 21 connecting between the connector 10 and the connector 30, the braided shield 26 covering the three coated wires 21 and connecting between the connector 10 and the connector 30, and the protection tube 27 covering the exterior of the braided shield 26. The terminal housing 11 corresponding to the “first terminal housing” includes the three nozzle-shaped members 16, which are the “first nozzle-shaped members” for receiving the respective first ends of the coated wires 21 on the connector 10 side (the first end side). Further, the terminal housing 31 corresponding to the “second terminal housing” includes the three nozzle-shaped members 36, which are the “second nozzle-shaped members” for receiving the respective second ends of the coated wires 21 on the connector 30 side (the second end side). The outer surface of a part of each coated wire 21 is covered with the insulating tube 24 serving as the first insulating member, the covered part being the part of the coated wire 21 extending between a first-end-side position 28′, which is a position spaced from the corresponding nozzle-shaped member 16 by distance d₁, and a second-end-side position 29′, which is a position spaced from the corresponding nozzle-shaped member 36 by distance d₂. A first end 25a of the tubular grommet 25 corresponding to the “third insulating member” is attached to an end face of the base 15 of the terminal housing 11. A second end 25b of the grommet 25 extends to the outer surfaces of the insulating tubes 24. In other words, the grommet 25 is arranged overlapping the outer periphery of the insulating tubes 24 covering the outer surfaces of the three coated wires 21. Further, a first end 40a of the tubular protector 40 corresponding to the “fourth insulating member” is attached to the terminal housing 31. A second end 40b of the protector 40 extends to parts of the coated wires 21 covered with the insulating tubes 24. In other words, the protector 40 is arranged overlapping the outer periphery of the insulating tubes 24 covering the outer surfaces of the three coated wires 21. The grommet 25 is composed of a resilient material such as rubber, and is bendable together with the coated wires 21 inserted therein. In contrast, the protector 40 is a rigid component manufactured by resin molding or the like, and physically defines the route of the coated wires 21 inserted therein to be bent at 90 degrees, as shown in FIG. 3B.

According to the present embodiment, similarly to in the embodiments described with reference to FIGS. 1 and 2, over the entire connecting cable 300, the conductors 22 of the three coated wires 21 are always insulated by two or more insulating layers. As a result, insulating performance of the overall connecting cable 300 can be enhanced.

While the connecting cables 100, 200, 300 according to the above-described embodiments are each explained as including three coated wires 21, the connecting cables 100, 200, 300 may alternatively include only one coated wire 21, or four or more coated wires 21.

The present invention is not limited to the above-described embodiments, and is intended to encompass all changes and modifications that may be made without departing from the scope and spirit of the present invention defined in the claims.

1. A connecting cable, comprising:
at least one coated wire formed by coating a conductor with an insulating coating material;
a terminal housing having a nozzle-shaped member for receiving one end portion of the coated wire;
a first insulating member spaced from the nozzle-shaped member and covering an outer surface of the coated wire; and
a second insulating member attached to the terminal housing and arranged overlapping an outer periphery of the first insulating member, the second insulating member having a tubular shape into which the coated wire is inserted.

2. The connecting cable according to claim 1, wherein the nozzle-shaped member and a part of the coated wire covered with the first insulating member are inserted inside the second insulating member.

3. The connecting cable according to claim 2, wherein the second insulating member is bendable together with the at least one coated wire inserted therein.

4. The connecting cable according to claim 2, wherein the second insulating member physically defines a route of the at least one coated wire inserted therein.

5. A connecting cable, comprising:
at least one coated wire formed by coating a conductor with an insulating coating material;
a first terminal housing having at least one first nozzle-shaped member for receiving a portion of the coated wire on a first end side;
a second terminal housing having at least one second nozzle-shaped member for receiving a portion of the coated wire on a second end side;
a first insulating member spaced from the first nozzle-shaped member and the second nozzle-shaped member and covering an outer surface of the coated wire;
a third insulating member attached to the first terminal housing and arranged overlapping an outer periphery of the first insulating member, the third insulating member having a tubular shape into which the coated wire is inserted; and
a fourth insulating member attached to the second terminal housing and arranged overlapping an outer periphery of the first insulating member, the fourth insulating member having a tubular shape into which the coated wire is inserted, wherein
the third insulating member is bendable together with the at least one coated wire inserted therein, and
the fourth insulating member physically defines a route of the at least one coated wire inserted therein.

6. The connecting cable according to claim 5, wherein
the first nozzle-shaped member and a part of the coated wire located on the first end side and covered with the first insulating member are inserted inside the third insulating member, and
the second nozzle-shaped member and a part of the coated wire located on the second end side and covered with the first insulating member are inserted inside the fourth insulating member.
